(19) United States
(12) Patent Application Publication
(10) Pub. No.: US 2026/0176884 A1
(43) Pub. Date: Jun. 25, 2026

(54) FACADE CLEANING MACHINE

(71) Applicant: MELRO CORRÊA Marcelo De Freitas, Porto Alegre (BR)

(72) Inventors: Marcelo De Freitas Melro Correa, Porto Alegre (BR); Felipe Arbogast Diefenthaler, Viamao (BR); Andre Schaan Casagrande, Porto Alegre (BR); Tiago De Menezes Arial, Porto Alegre (BR); Boris Nahuel Rojo Tanzi, Porto Alegre (BR)

(21) Appl. No.: 18/728,863

(22) PCT Filed: Dec. 7, 2022
(86) PCT No.: PCT/BR2022/050485

§ 371 Date: Jul. 12, 2024

(30) Foreign Application Priority Data
Jan. 13, 2022 (BR) BR102022000685-7

(51) Int. Cl. A47L 11/34; A47L 11/40; B08B 1/34

(52) U.S. Cl. CPC E04G 23/002; A47L 11/34; A47L 11/4041; A47L 11/4044; A47L 11/4055; A47L 11/4088; A47L 11/4091; B08B 1/34

(57) ABSTRACT

The facade cleaning machine is comprised of a chassis (1), brushes (2) with misaligned bearings (2-A) for cleaning the facade, internal (2-B) and external (2-C) cleaning rollers driven by the electrical motor (4) disposed on the sides of the chassis (1), skis (5) for protecting the facade and facilitate navigating bumps, spray rulers (6), removeable side wheels (7) for protecting the facade when washing inner corners or for slanted surfaces, fairing (8) with encasement for the ventilator (3) which keeps the machine close to the facade of the building. The machine in use hangs from a cable fastened to the through-wire winch normally fastened at the top of the building, guiding the movement of the machine, either on the vertical wall or on other slanted surfaces or otherwise.

### TECHNICAL FIELD

The present invention belongs to the sector of cleaning machines. More specifically it refers to a building facade cleaning machine comprising an optimized chassis, ventilator for generating thrust, electrical motors, sprayers, brushes fastened by misaligned bearings for cleaning the facade, removeable side wheels to protect inner corners and skis to protect the facade and facilitate navigating bumps, controlled by a cable fastened to the through-wire winch fixed to the top of the building for movement over the entire facade.

### STATE OF THE ART

Some techniques are traditionally used to clean facades, the most common being industrial mountaineering, which is performed by a worker hanging outdoors on a cable, manually cleaning the panes and facades. One drawback of this technique is the risk that the worker runs in doing this job, being vulnerable to various risks, such as storms and equipment mal-functioning, endangering his own life. There is also the potential discomfort to the tenants due to the invasion of privacy and longer time to perform the service. The other drawback in this sense is the speed of performing the task, being entirely manual.

The alternative which is used to this model of industrial mountaineering, also with manual labor, is the use of rocker arms as a platform, where the worker is also hung high up from buildings, but is able to move sideways with greater ease, transporting more products and persons and thus enabling a greater capacity for cleaning in terms of speed, but maintaining the risk of falling.

To put an end to danger in the profession, another solution has been created: autonomous facade-cleaning machines, proposing the partial or total elimination of the worker hung from the building to perform the cleaning.

Patent document U.S. Pat. No. 6,550,090 describes a machine for cleaning the external wall of a building comprising a box split into chambers with rubber plates or brushes with the possibility of ejecting liquid solutions to rub on and clean the facade, having a rotary propeller to keep the machine close to the pane, with steel and rubber plates to assist in cleaning and steel plates to optimize the strength exerted by the brush. This machinery hangs from a cable fastened to the top floor of the building and is moved vertically by this cable. The limitations of this type of machinery are the trails left on the facade due to the alignment of the brushes, and the presence of steel plates just to optimize strength, regulated by way of screws, needing human work and without suitable support for the motion of the machine over the facade.

Patent document US2013081652 describes a facade cleaning machine with a rotary brush, wherein the machine uses steering guides, wind poles, apparatus stretched across the facade of the building so that the wheels of the machine move in their grooves, and facade panels to move around and to clean the facade. One limitation of this type of machinery is the need to use various elements to keep the machinery close to the facade and moving, making the work more time-consuming, complex and less versatile due to the need to adapt all the elements to the facade.

Patent document US2019321868 describes a facade cleaning machine comprising a cleaning brush, wheels and a ventilator, responsible for producing the strength to guarantee adherence of the device to the wall of the building, with sensors and artificial intelligence that detects the surface of the facade. This type of machinery has the limitation of containing wheels for movement thereof on the facade, thus hampering its locomotion on surfaces that are irregular and hard to reach, moreover, containing parallel bearings, the support rail and the outer and inner corners of the facade are consequently not cleaned.

There are also machines for cleaning facades that couple small side brushes for washing inner corners, but same are unable to wash the outer corners of the building and leave trails created by the very bearings/wheels of the machine.

### NOVELTIES AND OBJECTIVE OF THE INVENTION

The objective of the present invention is a building facade cleaning machine that effectively overcomes the limitations of the state of the art referred to previously.

The facade cleaning machine is comprised of a chassis, fairing with encasement for the ventilator that keeps the machine close to the facade of the building, removeable side wheels (to protect the side facade-in the case of washing the inner corners) to protect the facade, skis to protect the facade and assistance with navigating bumps, sprayer rulers and brushes with misaligned bearings which clean the facade without leaving trails, are driven by electrical motor disposed in the chassis. The machine in use hangs by a cable fastened to the through-wire winch fixed to the top of the building, guiding the movement of the device. Despite its span of 3 (three) meters, the machine has an extremely reduced weight owing to a series of characteristics such as optimized structure of the chassis, controls and winch at the top, among others, making cleaning more efficient, quicker and economical in terms of consumption of both water and electricity.

Alternatively, the machine has retractable wheels enabling transport of the equipment, and can be folded down such that the machine is supported by rubber feet guaranteeing that same does not slide easily over slanted surfaces.

More alternatively the machine can also operate on non-vertical surfaces by adding “skates”, front wheels, on the structure, making it possible to clean panes, solar panels, membrane roof (such as in stadiums), etc.

### ADVANTAGES AND TECHNICAL EFFECTS OF THE INVENTION

The building facade cleaning machine, object of the present invention, results in the following advantages and achieves the following technical effects on the cleaning machines from the state of the art:
The constructivity of state-of-the-art cleaning machines makes it hard (or even impossible) to clean the corners of buildings, meaning the machine does not entirely eliminate the work risk of an operator hanging outdoors, so there is a complementary need for manual cleaning to wash the corner areas and the trail of the bearings. Solved by the present invention by a machine with a set of brushes sectioned into three rollers, an internal roller and two external rollers, which may exceed the size of the structure of the machine and so perform the cleaning of the internal and external corners of the facades of buildings, jointly with a chassis having a fine thickness profile which enables the inversion of the bearings of the brushes, leaving no trails created by the machine, since one brush cleans the trail left by the other. And it is possible to couple cup-brushes or the like for washing details of the building;
The cleaning machines from the state of the art have wheels at their ends, making it difficult (or even impossible) to clean the corners of buildings. Solved by the present invention by way of a machine with brush at its ends.;
The cleaning machines from the state of the art have wheels for protecting the building facade, this constructivity makes it harder to protect the facade, because, if the wheel loses contact with the facade, it may collide directly with it and having an optimized geometry it will damage it. Solved by the present invention by using “skis” instead of wheels, for protection against the facade, which due to the flexibility create smoothness in an eventual collision against the structure, absorbing the shock and avoiding contact with the parts of the machine that might damage the facade.;
The cleaning machines from the state of the art have wheels for their locomotion, making it hard to move the the machine over obstacles, architectural details, as the wheel might get stuck on the facade. Solved by the present invention by using “skis” instead of wheels, since the curvature of the skis accompanying the profile of the machine and a greater contact area guarantees that same will accompany the surface of the facade with smoothness even in the presence of architectural obstacles;
The cleaning machines from the state of the art have aligned bearings when using more than one shaft of brushes, thus leaving trails due to the space necessary to join the brushes to the chassis. Solved by the present invention by using two brushes in the same machine with misaligned bearings that cause one to clean the trail left by the other;
The cleaning machines from the state of the art have chassis made of thick sheets or metal profiles that create coarse trails without cleaning on the facade and fail to use a possible inversion of bearings such that the brushes wash the trail of one another. Solved by the present invention by a chassis with fine, corrugated 3 mm sheets enabling the inversion of the bearings and thus not leaving cleaning trails;
The cleaning machines from the state of the art contain a high weight due to their thick sheets and the presence of controls and winch on the machine. Solved by the present invention by chassis with fine, corrugated 3 mm sheets made of light alloy or carbon steel and with hydraulic and electric controls, and winch fastened at the top of the building, leaving on the machine only the equipment to be used in cleaning.
The cleaning machines from the state of the art have exposed sides and corners, which may collide against the facade and damage it. Solved by the present invention by removeable side wheels which protect the facade of inner corners;
The cleaning machines from the state of the art have sprayers that inject just one type of liquid solution at a time. Solved by the present invention by way of two independent spray rulers, where it is possible to use different liquid solutions in each ruler;
The cleaning machines from the state of the art contain a large sized chassis, hampering the transport thereof and having a heavy weight. Solved by the present invention by way of a chassis measuring 1.5 m and adjustable brushes between 1.5 m and 3 m;
The cleaning machines from the state of the art are sized and constructed for application on vertical facade buildings, or for roofs. Solved by the present invention by installing “skates”, front wheels, for using the machine on any type of vertical, slanted or even horizontal surface;
The cleaning machines from the state of the art run the risk of falling in the event that the main cable breaks. Solved by inserting a fall-safe lock and an independently-anchored auxiliary cable; and
The cleaning machines from the state of the art have the risk of locking in the operation at hand either due to some mechanical problem in the winch or owing to lack of electricity. Solved by the use of through-wire winch fastened to the top of the building, in which there is simplified access and that even if there is a fall or electricity outage, it can be manually and easily driven so as to lower the equipment.

### LIST OF ACCOMPANYING DRAWINGS

In order that the present invention be fully understood and put into practice by any skilled person from this technological sector, it is now described in a clear, precise and sufficient manner, based on the accompanying drawings, listed below, which illustrate preferred embodiments of the cleaning machine:

FIG. 1—perspective top view of the facade cleaning machine;

FIG. 2—perspective bottom view of the facade cleaning machine;

FIG. 3—perspective blown-up bottom view of the facade cleaning machine;

FIG. 4—perspective blown-up top view of the facade cleaning machine with central sheet hidden;

FIG. 5—bottom view of the facade cleaning machine;

FIG. 6—front view of the cleaning brushes of the present invention;

FIG. 7—perspective blown-up top view of the cleaning brush of the present invention;

FIG. 8—perspective front view of the ski of the present invention;

FIG. 9—perspective rear view of the ski of the present invention;

FIG. 10—perspective top view of the chassis of the present invention;

FIG. 11—illustrates the cleaning of outer corners by the machine of the present invention;

FIG. 12—illustrates the cleaning of inner corners by the machine of the present invention; and

FIG. 13—bottom perspective view of the machine in an alternative option to clean the non-vertical surfaces with front wheels.

### DETAILED DESCRIPTION OF THE INVENTION

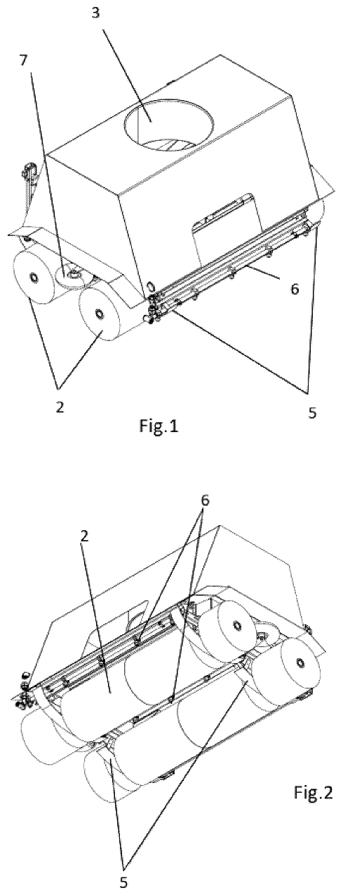

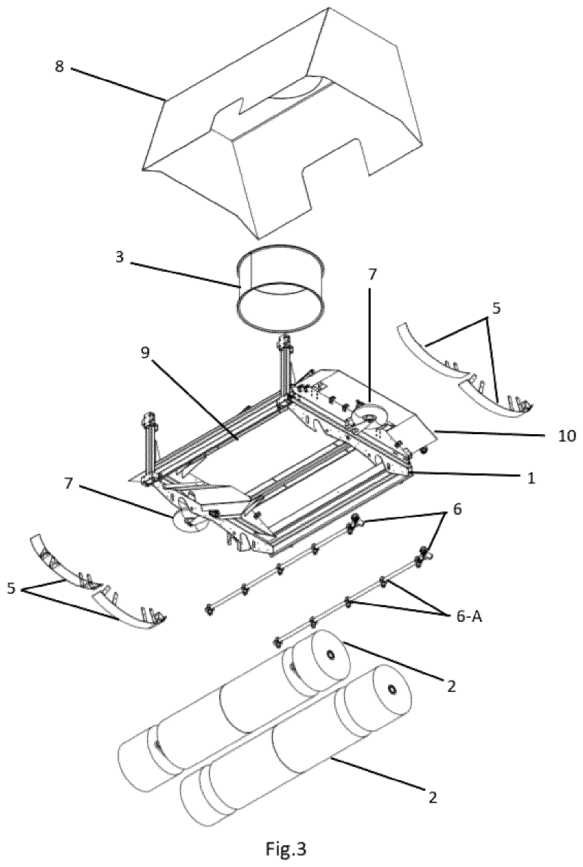

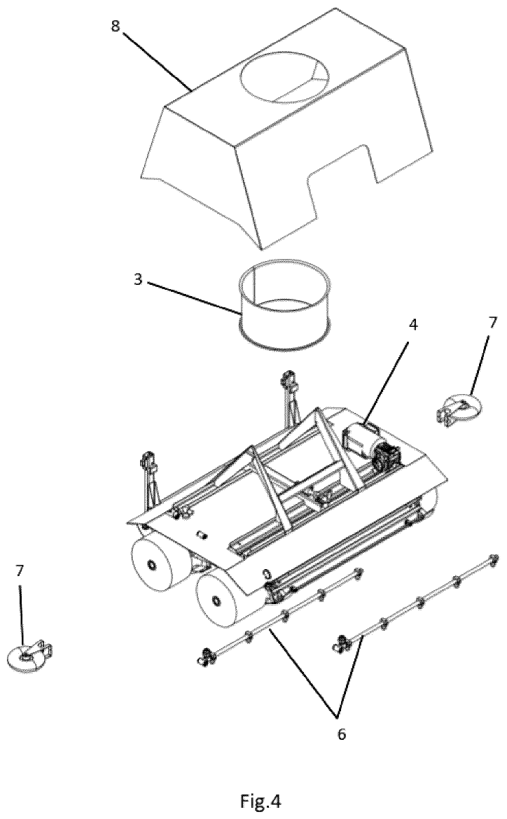

FIGS. 1, 2, 3 and 4 and 5 illustrate the facade cleaning machine comprising a chassis (1) endowed with profiles (1-A) made of light alloy metal material, carbon steel or the like, preferably aluminum, fastened together, two transversal profiles (1-B) fastened to the support (1-C) and to the profiles (1-A), support (1-C) fastened to the transversal profiles (1-B) with encasement for the ventilator (3), and support profiles (1-D) fastened to the profile (1-A); two cleaning brushes (2) with adjustable length between 1.5 m and 3 m with four bearings (2-A) disposed in a misaligned manner, internally and externally to the profile (1-A); ventilator (3) linked to the electrical motor (4) fastened to the support (1-C); electrical motors (4) fastened to the chassis (1); four skis (5) disposed and fastened in a misaligned manner, internally and externally to the metal profile (1-A) on the sides of the chassis (1); two sprayer rulers (6) each endowed with a bar having capacity to accommodate at least four spray nozzles (6-A) and each of the two tubulations can be fed by different fluid, encased in the holes of the chassis (1); two removeable side wheels (7) fastened to the profiles (1-A) of the chassis (1) by way of screws, rivets or the like; fairing (8) involving the upper part of the machine; central sheet (9); and side sheets (10).

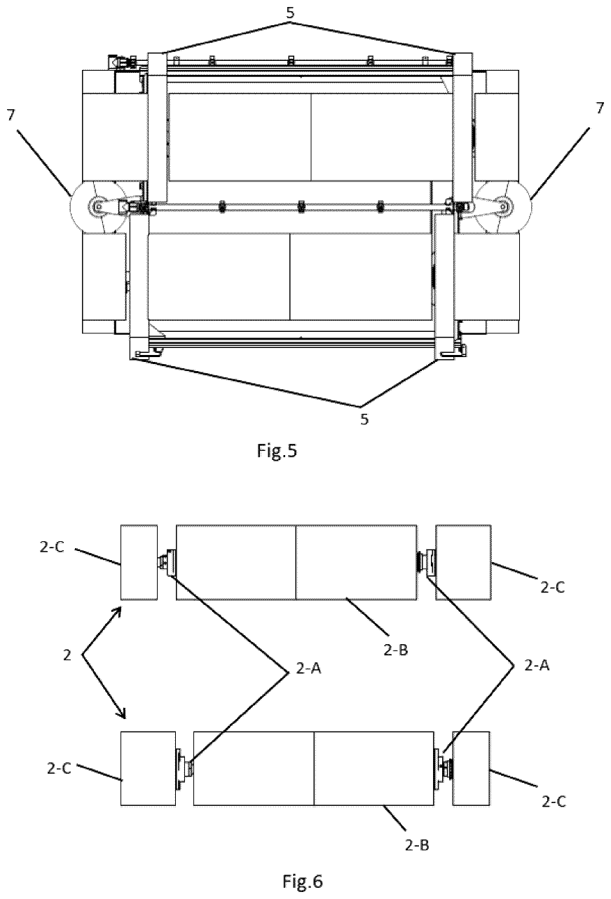

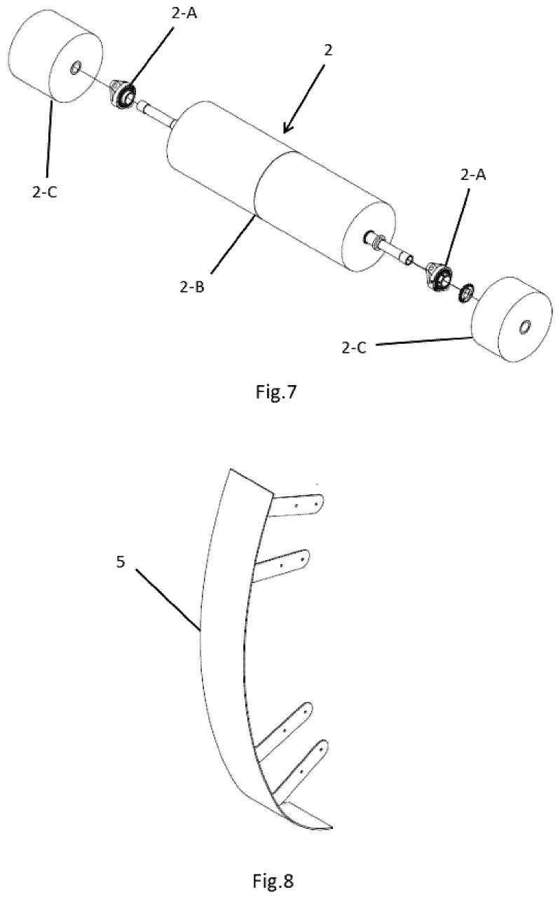

FIGS. 6 and 7 detail the cleaning brushes (2) that comprise at least three cleaning rollers, one internal (2-B) and two external (2-C), one shaft, cogs and bearings for supporting the brushes (2) to the chassis (1), with brushes (2) of adjustable size between 1.5 m and 3 m, pursuant to the need of the facade and facilitating transport thereof.

The drawings of the cleaning brushes also illustrate the positioning of the misaligned bearings (2-A), this arrangement causes the cleaning of the building facade to be more efficient, with one brush cleaning the support trail of the other, thus not failing to clean trails.

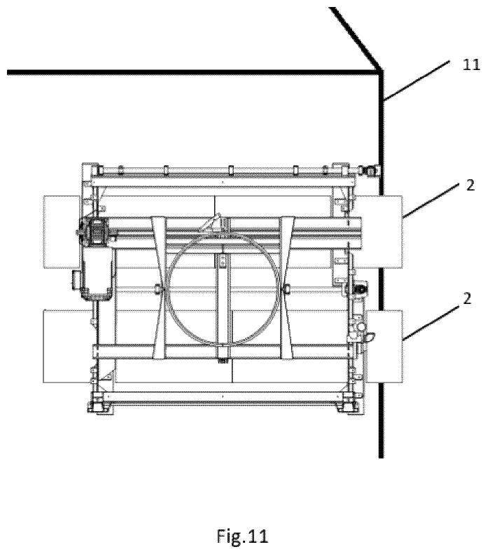

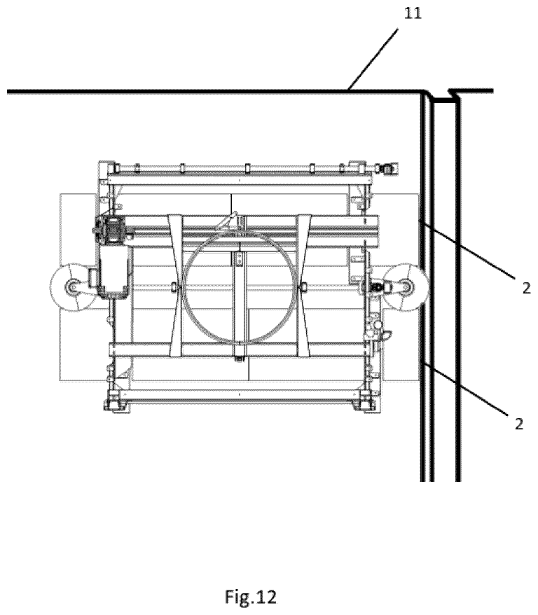

The set of characteristics, described above, of the cleaning brushes (2), with internal (2-B), external (2-B) rollers and misaligned bearings (2-A), the size varying between 1.5 m and 3 m, provides total replacement of a man's work in the activity of cleaning building facades, cleaning all the trails created by the very machine and reaching the external and internal corners of the facade (11), illustrated in FIGS. 11 and 12. And cleaning brushes (2) may also be coupled to cup brushes or the like at the ends of their axes for cleaning the side facade or inner corners.

FIGS. 5, 8 and 9 detail the skis (5) which consist of a support base for the machine to move across the building facade, with a surface that is not abrasive to the facade, for protection and with a length and width that prevents the machine from locking while it moves across the facade.

With a machine containing the skis (5) for protection against the facade, with the internal rollers (2-B) between the skis (5), and external rollers (2-C) on the outside of the skis.

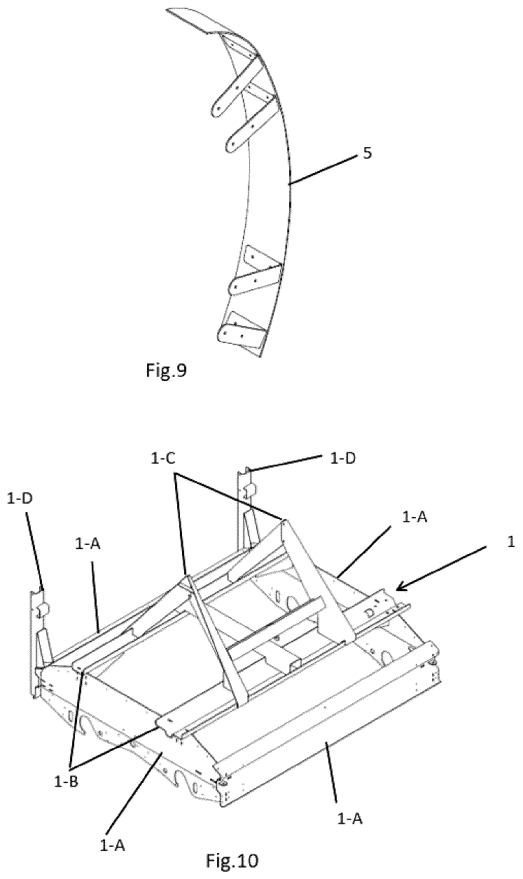

FIG. 10 details the chassis (1) of the present invention, with 1.5 m in length and showing its encasements and holes for fixing the elements and its profiles (1-A), (1-B) and (1-D) structure comprised of fine sheets of aluminum.

The present invention contains removeable side wheels (7) so they protect the facade from a possible collision between the machine and the building, if the machine moves sideways while washing the inner corners, avoiding damage to the facade.

And for improved safety of the machinery, a three-legged steel cable sling is used, connecting the structure to the main cable, bringing stability during the working thereof, and a fall-safe lock device, a safety cable auxiliary to the main one, fastened at a different anchoring point to the main cable, which will be driven if the main cable breaks or any other problem occurs.

In order to carry out the washing of the facades of buildings, the machine is hoisted and moved by way of a cable fastened to the motor of the through-wire winch, fixed on top of the building, moving across the facade;

Once the machine is positioned to carry out the cleaning, a liquid solution is sprayed by the sprayers (6-A) on the facade of the building and driving the electrical motor (4) which activates the brushes (2) performing the cleaning of the facade with the sprayed solution.

During the entire period in which the machine is hoisted, the ventilator (3) remains operative, thus guaranteeing that same does not move away from the facade and has enough contact strength to perform the cleaning, the ventilator (3) generates thrust through the air mass displaced in a direction opposite to that of the facade.

To make the machine lighter, facilitate the transport and maintenance thereof, and use less electricity, the through-wire winch, the electric and hydraulic controls, and the power system are disposed at the top of the building, with only that equipment needed for cleaning remaining in the hoisted machine.

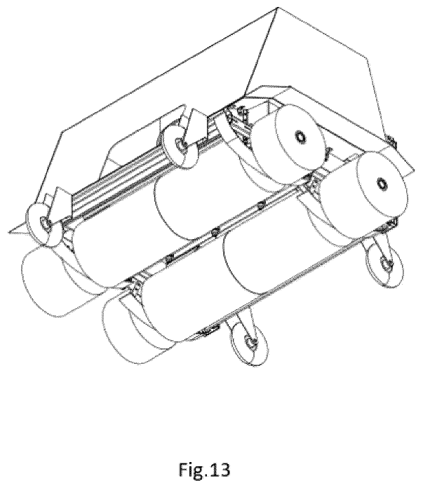

FIG. 13 illustrates the machine in its alternative to be used on roofs or other slanted surfaces, regardless of inclination, due to its lightness and its “skates” which may be coupled for said function with the installation of horizontal wheels for its movement on the non-vertical (slanted or horizontal) surface.

Optionally, the machine may bounce off the wheels on its base, fastened to the chassis, to facilitate the movement of the machinery for the ground while it is transported to the building where it will perform the cleaning.

It is emphasized that the drawings and description presented herein are not intended to limit the embodiments of the inventive concept now proposed, but rather to illustrate and render comprehensible the conceptual innovations disclosed by the invention. Accordingly, the descriptions and images should be interpreted as exemplary and not limitative, and there may be other equivalent or analog forms of implementation that should be considered within the scope of the present invention.

The present specification refers to a machine for cleaning facades resulting in a new technical effect relative to the state of the art, thus proving its novelty, inventive activity, descriptive sufficiency [full disclosure] and industrial application, in compliance with all the requirements for the grant of a patent of invention.

1-8. (canceled)

9. A facade cleaning machine comprising a chassis; at least two cleaning brushes; an electrical motor; one or more spray nozzles; a fairing comprising the upper part of the machine; a central sheet; and side sheets comprising skis for protecting the facade and assistance in navigating bumps, with cleaning brushes containing internal rollers positioned between the skis, and external rollers on the outside of the skis.

10. The machine of claim 9, wherein the cleaning brushes comprise misaligned cleaning brushes, with bearings disposed in a misaligned manner causing the skis to be vertically misaligned as well.

11. The machine of claim 9, wherein the chassis comprises a fine sheet of light alloy material or carbon steel; and wherein the cleaning brushes comprise two rotary cleaning brushes with four bearings disposed in a misaligned manner; an further comprising a ventilator; and wherein the skis are disposed in a misaligned manner, on the sides of the chassis; and further comprising at least two spray rulers having a bar configured to accommodate different numbers of the spray nozzles and different products in each of the rulers;; and further comprising at least two side wheels configured to be removable and replaceable by four-wheel skates.

12. The machine of claim 9, wherein the chassis is at least 1.5 m in length and further comprising one or more profiles fastened with at least two transversal profiles, and one or more supports fastened to the transversal profiles with encasement for the ventilator and support profiles, all of which are made of fine sheets of light alloy material or carbon steel.

13. The machine of claim 9, further comprising folding wheels for transporting the machinery.

14. The machine of claim 9, wherein the cleaning brushes comprise one or more rotary cleaning brushes with adjustable length between 1.5 m and 3 m, and further configured for adapting rotary cup-type brushes at the ends, or rotary brushes having larger diameters.

15. The machine of claim 9, wherein the chassis is made of corrugated aluminum sheets being at least 3 mm thick.

16. The machine of claim 9, further comprising at least four front wheels installed on the chassis for movement on non-vertical surfaces.
